(19) United States
(12) Patent Application Publication
(10) Pub. No.: US 2009/0148596 A1
(43) Pub. Date: Jun. 11, 2009

(54) Concrete Curing Blanket, Method of Making Same, and Method of Curing Concrete

(76) Inventors: Michael E. Carroll, Loganville, GA (US); Stephen F. McDonald, Loganville, GA (US)

Correspondence Address: EMERGING STRATEGIES, LLP, 7416 LYNNHURST STREET, CHEVY CHASE, MD, 20815-3102, US

(21) Appl. No.: 11/953,012

(22) Filed: Dec. 7, 2007

(51) Int. Cl. B32B 3/00; B65B 33/00

(52) U.S. Cl. 427/154; 428/57

(57) ABSTRACT

Disclosed is a concrete curing blanket including an impervious layer, an absorbent layer and a responsive layer between the impervious layer and the absorbent layer that exhibits a response corresponding to one or more conditions related to curing concrete. Methods of making and curing concrete with same also are disclosed.

### BACKGROUND OF THE INVENTION

Producing quality hydraulic concrete or cement requires proper curing. Curing increases concrete strength, hence structural value. Proper curing is necessary for producing water-tight, durable concrete.

The most common hydraulic cement for construction purposes is Portland cement. Portland cement is a heat-treated mixture primarily of calcium carbonate-rich material, such as limestone, marl or chalk, and material that is rich in Al₂SiO₂, such as clay or shale. Portland cement comes in several varieties that are distinguished by such characteristics as the rate of acquiring strength during curing, the amount of heat of hydration generated, and resistance to sulfate attack. Other types of hydraulic cements include aluminous cement, chalcedony cement, which is made from amorphous quartz, and Roman cement, which combines burnt clay or volcanic ash with lime and sand.

“Concrete” describes a mixture of stone, gravel or brushed rock and sand, referred to as “aggregate,” which is bound by a cement. As used herein, “concrete” includes reinforced concrete, concrete that contains organic or silica-based fibers or metallic wire, cable or rods as a reinforcing substance, and polymer-cement concrete that is bound with Portland cement and a polymerized monomer or resin system. Hydraulic concrete and cement are referred to herein as “concrete.” Additional information on the composition and characteristics of concrete may be found in Basic Construction Materials by C. A. Herubin and T. W. Narotta, third edition, Reston Book, Englewood, N.J., which is incorporated herein by reference.

Curing involves chemical changes that result in setting and hardening. These chemical changes occur over a considerable period of time in the presence of water. Hydration is important in the curing of hydraulic concretes, i.e., concretes that are dependent on a hydration reaction for hardening, and concretes that are bound with hydraulic concretes. Ideally, concrete should be kept wet after it has set for as long a period as is practicable.

Maintaining an optimal amount of water in contact with curing concrete optimizes the strength and durability of the concrete. For example, if concrete is kept wet for the first ten days after setting, strength and durability thereof increase 75 percent over ordinary aging at dry surface conditions. As reported by Ken Hover in Curing and Hydration: Two Half Truths Don't Make a Whole, published in the summer 2002 edition of the Concrete News by L & M Construction Chronicles, the more water that is made available to the concrete during curing, the better.

To keep concrete hydrated, the concrete industry has come to rely on concrete curing blankets for covering wetted concrete and extending the duration of damp conditions on the curing surface thereof. Some concrete curing blankets have included burlap and cotton mats, wet rugs, moist earth or sand, sawdust and other coverings likely to act as a moisture barrier. Burlap-based blankets pose many problems, including hydrophillic greasiness; large voids that promote non-uniform concrete surface wetting; stiffness and non-resiliency that prevents conformity to surface irregularities; and fibers that snag on concrete surfaces, which may lead to undesired markings. Cotton mats tend to disintegrate well before the desired curing duration, leaving clumps of material stuck on the surface requiring refinishing. Some concrete curing blankets also have included moisture barriers, such as water-proof papers and plastic films. While films may help reduce evaporation, they do not cure problems associated with underlying absorbent layer.

A recent concrete curing blanket, known in the industry as Ultracure™, avoids the issues described above with an absorbent layer of airlaid natural cellulose fibers latex or thermally bonded on an impervious backing, as described in U.S. Patent Application Publications 2005/0042957, 2006/0019064 and 2005/0214507, which are incorporated herein by reference. Because of its unusually absorbent and pliable properties, the Ultracure™ curing blanket also provides more moisture to the surface of curing concrete more uniformly than any other curing blanket. Because the smooth side of the airlaid layer, the surface formed on the wire or mesh during fabrication, is disposed against the concrete, the Ultracure™ curing blanket promotes a smooth finished surface on the concrete that major retailers are proud to display as primary flooring.

As used herein, “airlaid” refers to a fibrous structure formed primarily by a process involving deposition of air-entrained fibers onto a mat, typically with binder fibers, and typically followed by densification and thermal bonding. In addition to traditional thermally bonded airlaid structures, those formed with non-tacky binder material and substantial thermally bonded, “airlaid,” according to the present invention, also includes co-form, which is produced by combining air-entrained dry, dispersed cellulosic fibers with meltblown synthetic polymer fibers while the polymer fibers are still tacky.

“Airlaid” also includes an airformed web to which binder material is added subsequently. Binder may be added to an airformed web in liquid form, e.g., an aqueous solution or a melt, by spray nozzles, direction injection or impregnation, vacuum drawing, foam impregnation, and so forth. Solid binder particles also may be added by mechanical or pneumatic means.

While the pliability of Ultracure™ curing blanket and its inherent tendency wick moisture therethrough promotes more uniform distribution of available water over a curing concrete surface, optimal curing may be defeated by an inadequate supply of available water from the start. Even though the clear, transparent or opaque backing of the Ultracure™ curing blanket permits viewing whether bubbles have formed, it remains difficult to know whether enough water is available throughout the surface.

What is needed is a concrete curing blanket that indicates when sufficient water is available to curing concrete.

### SUMMARY OF THE INVENTION

The invention is a concrete curing blanket that indicates when sufficient water is available to curing concrete. To that end, the invention is a concrete curing blanket including an impervious layer, an absorbent layer and a responsive layer between the impervious layer and the absorbent layer that exhibits a response corresponding to one or more conditions related to curing concrete. The invention also includes methods of making and curing concrete with same.

The invention provides improved elements and arrangements thereof, for the purposes described, which are inexpensive, dependable and effective in accomplishing intended purposes of the invention. Other features and advantages of the present invention will become apparent from the following description of the preferred embodiments which refers to the accompanying drawing.

### BRIEF DESCRIPTION OF THE DRAWINGS

The invention is described in detail below with reference to the following figures, throughout which similar reference characters denote corresponding features consistently, wherein:

FIG. 1 is a vertical cross-sectional detail view of an embodiment of a curing blanket constructed according to principles of the invention;

FIG. 2 is an environmental perspective view of the embodiment of FIG. 1;

FIG. 3 is a schematic view of a method of curing concrete according to principles of the invention;

FIGS. 4-10 are graphical representations of properties of the embodiment of FIG. 1;

FIG. 11 is a schematic view of a method of making a curing concrete according to principles of the invention;

FIG. 12 is vertical cross-sectional detail view of the embodiment of FIG. 1 on a surface drawn to a smaller scale;

FIG. 13 is a plan view of the embodiment of FIG. 1; and

FIG. 14 is a vertical cross-sectional detail view of overlapping trimmed embodiments of FIG. 1.

### DETAILED DESCRIPTION OF THE PREFERRED EMBODIMENTS

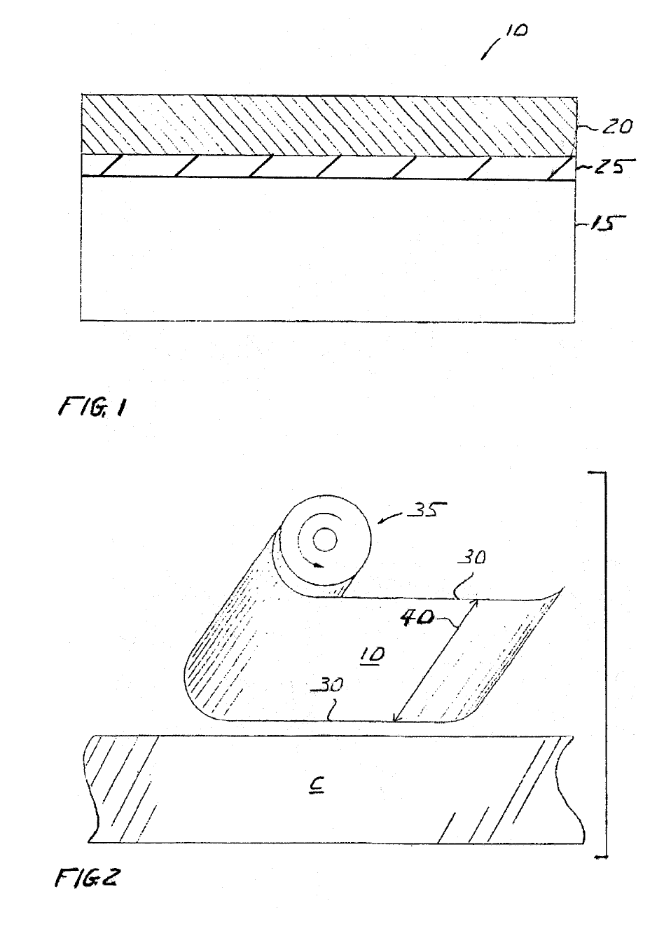

Referring to FIG. 1, an embodiment of a concrete curing blanket 10 constructed according to principles of the invention has an absorbent layer 15 disposed on an impervious layer 20 with an interposed responsive layer 25. Responsive layer 25 exhibits a response that corresponds to one or more conditions related to curing concrete that aids in determining whether sufficient water is available for optimal curing. If available, concrete curing blanket 10 maintains the optimal amount of water in contact with an entire surface of curing concrete, which optimizes the strength and durability of the concrete when cured.

Preferably, absorbent layer 15 is airlaid, as described above. Because airlaid hydrogen bonded materials tend to disintegrate with prolonged exposure to water, airlaid natural fiber mats have not been considered optimal for concrete curing. The invention overcomes this problem by incorporating natural cellulose material with synthetic and multibond fibers in the resultant airlaid structure.

Absorbent layer 15 contains bi-component or multibond fibers, fluff pulp, ethylene vinyl acetate and latex. More specifically, absorbent layer 15 includes 5-50%, preferably 30%, synthetic bonding fibers. Synthetic fibers contribute as much as 3.8-4.25%, preferably 4%, by weight. Bi-component and multibond fibers are coaxial fibers having an inner component with a higher melting temperature than an encasing outer component. When heated, the outer component melts for bonding with other elements, while the inner component does not melt, thus lending integrity and strength to the bonded material. The inner and outer components may be selected from polypropylene, polyethylene or other compositions suitable for the purposes described.

Absorbent layer 15 also includes 50-89%, preferably 70%, natural cellulose fluffed pulp fiber. The fluff pulp, preferably, is derived from southern softwood, northern softwood, southern hardwood, northern hardwood, kanaf or eucalypus fibers. These materials provide short fibers that offer great surface area for trapping and absorbing water. The fibers derived from protein based, cotton, agave, plant stalk (bast) fibers of other mats tend to be much longer, hence afford less surface area for trapping and absorbing water. These longer fibers also have waxes, resins and some lignin present that discourage entrapping water. These longer fibers are less absorbent and exhibit geometries that are not as favorable as the present cellulose from soft and/or hardwood fibers. Further, the pulp fibers of the present invention also tend to provide greater tensile strength than the fibers of other mats.

The fluff pulp of absorbent layer 15 is obtained from a Kraft process, rather than mechanical pulping. Mechanical pulping does not produce a clean product, free of the waxes, resins, silicone, turpentine that are present in the virgin materials recited above. Bleached Kraft pulp provides optimal absorption capabilities by producing clean cellulose. The Kraft process produces a bulkier cellulose with a white absorptive component that prevents discoloration of a concrete surface in contact therewith. Discoloration commonly occurred with burlap materials.

Ethylene vinyl acetate promotes great integrity and reduces dusting.

The latex bonding agent is sprayed on natural fibers or part of the bi-component or multibond fibers aids in strengthening the adhesion among the bi-component or multibond fibers and other materials in absorbent layer 15. The latex binders may contribute as much as 5-35%, preferably 20%, by weight.

Referring also to FIG. 2, the unique composition of concrete curing blanket 10 enables it to wick moisture from oversaturated areas to dry areas. As edges 30 of concrete curing blanket 10 dry, concrete curing blanket 10 wicks moisture from more hydrated areas to edges 30 and vice versa. Concrete curing blanket equalizes the moisture saturation level therethrough.

Another embodiment of absorbent layer 15 contains 5-20% super absorbent fibers. Super absorbent fibers are absorbent fibers coated with absorbent material.

Preferably, impervious layer 20 provides a vapor barrier, but not a protection barrier. To this end, impervious layer 20 may include an extruded or coated polyethylene or polymer latex material or film as a vapor- and/or fluid-impervious backing.

Absorbent layer 15 and impervious layer 20 may be thermally bonded in a basis weight ranging from 40 to 500 grams per square meter (gsm). Ideally, the latex material is a two-part manufactured composition that renders it insoluble in water. The water insolubility discourages disintegration of concrete curing blanket 10 or, more specifically, absorbent layer 15, which would lead to imperfections in the finished surface of a concrete slab. Absorbent layer 15, preferably, is spray coated, which lowers production costs.

One part of the latex composition is a high-viscosity polymer filler agent, while the other part is a water resistant agent obtained by polymerization. A binder dispersed in water forms films by fusion of the plastic filler particles as the water evaporates during manufacturing or curing.

Absorbent layer 15 and impervious layer 20 may be bonded with a special water resistant adhesive having a soft point of 210° F.

Alternatively, impervious layer 20 may provide for vapor and/or fluid transmission. To this end, impervious layer 20 may include a perforated film, preferably constructed of a polymer or metallic material. The number of perforations in impervious layer 20 may range from one to 500 per square foot. Each perforation has a diameter ranging from 0.001 mm to 0.1 mm. The perforations may define a pin hole, half moon hole, butterfly hole, full hole or other configuration suited for purposes described herein.

The perforations provide for rewetting curing concrete, where concrete curing blanket 10 is adapted to cure concrete, and vapor transmission, where concrete curing blanket 10 is adapted to absorptive applications. Perforated embodiments of impervious layer 20 are especially suited for curing concrete highway constructions, pavements, bridges and the like.

Impervious layer 20 may be UV enhanced and/or biodegradable. Impervious layer 20 may be opaque, with or without coloration, but preferably is clear or transparent. This allows for ready visual perception of water in concrete curing blanket 10 and on a slab surface, which realizes for owners and contractors tremendous labor savings in tending the curing slab and blanket to ensure that adequate water is present on all portions of a slab to be cured. Workers readily may see and take steps to eliminate bubbles or correct other non-uniformities with respect to contact between concrete curing blanket 10 to the surface of a curing concrete slab, or moisture provided thereby.

A target caliper or thickness for concrete curing blanket 10 is 0.5-5.0 mm, preferably 1.80 mm. A target tensile strength for concrete curing blanket 10 is 1295-1350 g/50 mm, preferably 1300 g/50 mm. A target absorbency for concrete curing blanket 10 is 16.5-18.5 g/g, preferably 17 g/g.

Responsive layer 25 is intended to give notice whether an appropriate amount of water is available for curing concrete. Accordingly, responsive layer 25 exhibits a response corresponding to one or more conditions related to curing concrete. The conditions include, inter alia, an amount of water, a pH level or a pH change.

Of the many techniques that may be employed, preferably, responsive layer 25 is a metallized layer, preferably of aluminum having an optical density ranging from 0.05 to 10.0, that reacts, preferably within 21-48 hours, to the change in pH that occurs in the available water on curing concrete due to the hydration reaction. As curing concrete hydrates, it absorbs ions and increases the pH in the available water from about 11 to 14, which in turn reduces responsive layer 25. The pH of cured concrete is about 12.5 or more.

The invention is configured so that, without the concrete curing, the available water will not achieve sufficient alkalinity to react with, reduce or dissolve the metalized or pigmented coating of responsive layer 25. In one embodiment of the invention, a clear impervious layer 20 is paired with a responsive layer 25 that is at least opaque or light reflective. As responsive layer 25 reacts, reduces or dissolves in the presence of water as described above, the non-translucence of responsive layer 25 becomes correspondingly light transmissive. Consequently, an appropriate amount of available water would allow a clear view of the curing concrete below, while an occluded view would signal an insufficiency of available water. Other embodiments of the invention provide for responses that manifest as color changes or other phenomena.

In operation, areas of concrete curing blanket 10 in which the appearance has changed commensurate with reduction of responsive layer 25 could be understood as areas where the curing concrete is fully hydrated for optimal curing. On the other hand, areas of concrete curing blanket 10 in which the appearance has not so changed could be understood as areas where the curing concrete is not yet fully hydrated, thus in need of more water. Consequently, concrete curing blanket 10 provides a ready indicator, which, if timely heeded, would ensure that the entire curing concrete surface is fully hydrated for optimal curing.

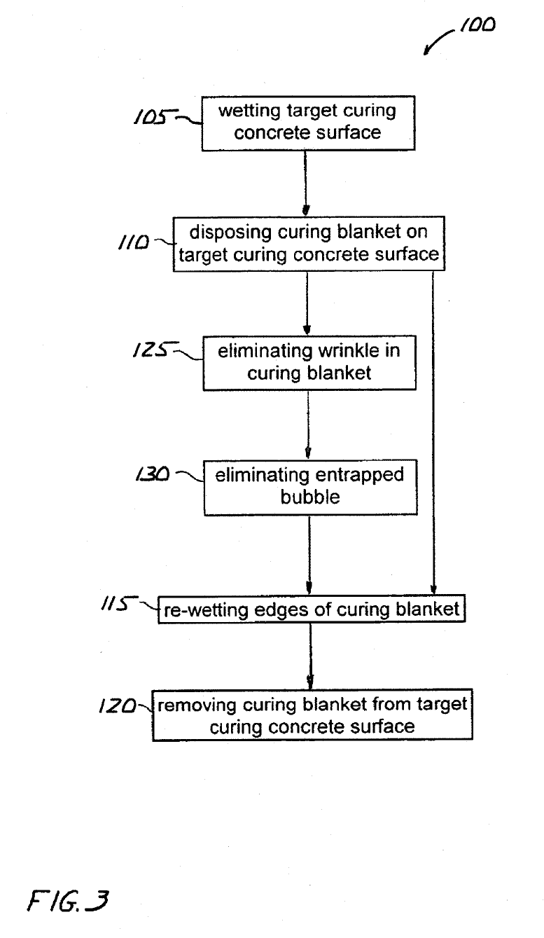

Referring to FIGS. 2 and 3, a method of curing concrete 100 according to principles of the invention includes a step 105 of wetting a target curing concrete surface C and a step 110 of disposing concrete curing blanket 10 on target curing concrete surface C with absorbent layer 15 nearest thereto. The method preferably includes a step 115 of re-wetting edges of concrete curing blanket 10 so that water wicks to all areas of concrete curing blanket 10. The method also includes a step 120 of removing concrete curing blanket 10 from target curing concrete surface C after target curing concrete surface C is cured.

In practice, prior to performing step 105 or step 110, a manufacturer ships rolls 35 of concrete curing blanket 10 on pallets (not shown) to a site where concrete is to be poured. On each roll 35, concrete curing blanket 10 has a width 40 defined by edges 30. Each pallet contains approximately twelve rolls 35 that provide approximately 10,000 square feet of coverage. Each roll 35 is encased and protected with shrink wrap (not shown) to minimize exposure to contamination until concrete curing blanket 10 is applied to target curing concrete surface C during the wet cure process. The shrink wrapping allows concrete curing blanket 10 to be stored outside during construction.

Step 105 involves misting or flooding target curing concrete surface C as specifications require.

After removing the protective shrink wrap (not shown), concrete workers perform step 110 by slowly rolling concrete curing blanket 10 onto target curing concrete surface C. Properly aligning and rolling concrete curing blanket 10 reduces the possibility of forming wrinkles in concrete curing blanket 10 or trapping air thereunder.

Once disposed on target curing concrete surface C, concrete curing blanket 10 becomes saturated with water and increases in weight dramatically. The weight increase allows for rolling out multiple adjacent lengths of concrete curing blanket 10, preferably with an overlap of two to four inches, without having to lap, tape, weigh down or otherwise restrain adjacent edges 30 to maintain uniform, void-free coverage of target curing concrete surface C. Since the airlaid structure of concrete curing blanket 10 is so absorptive and takes longer to dry out, moisture, hence weight, dissipate slower, further eliminating the need to restrain edges 30.

For best results, water should be allowed to pond in front of roll 35 as it is rolled along target curing concrete surface C.

In the unlikely event a wrinkle (not shown) occurs in concrete curing blanket 10 during application, the method may include a step 125 of eliminating a wrinkle in concrete curing blanket 10 which would be performed between step 110 and step 115. Step 125 may involve cutting concrete curing blanket 10 across width 40 of the affected area with a razor. Three- to four-foot sections on each side of the wrinkled area are peeled away then reapplied to target curing concrete surface C by gently, simultaneously stretching and lowering the sections back onto the wet cure surface.

Because concrete curing blanket 10 absorbs and retains significant amounts of water, concrete curing blanket 10 adheres to target curing concrete surface C like no other concrete curing blanket and insures a more complete, uniform wet cure and surface appearance that other concrete curing blankets.

In the unlikely event a bubble (not shown) forms under concrete curing blanket 10 after application, the method may include a step 130 of eliminating an entrapped bubble. Step 130 involves applying a roller squeegee or a wide soft bristle push-squeegee to guide the bubble (not shown) to the nearest unlapped edge 30. Squeegee roller application ensures 100% contact between concrete curing blanket 10 and target curing concrete surface C. Removing entrapped bubbles in this manner is preferred for slab on grade/tilt up construction projects.

Step 115, preferably, involves gently spraying water around edges 30 of concrete curing blanket 10 in an amount sufficient for concrete curing blanket 10 to wick water to all areas thereof and providing 100 percent humidity to target curing concrete surface C, as recommended for a wet curing application.

Step 120 involves folding concrete curing blanket 10 back onto itself in three- to four-foot sections until an entire concrete curing blanket section is folded. The foregoing is repeated until all of concrete curing blanket 10 disposed on target curing concrete surface C is folded into a removable condition. As concrete curing blanket 10 is intended for one-time use, once removed, folded concrete curing blanket 10 should be disposed of properly.

Embodiments of concrete curing blanket 10 have been tested extensively. Samples of concrete curing blanket 10 measured approximately 8 by 12 inches and had a 1.0 mm/ply thickness.

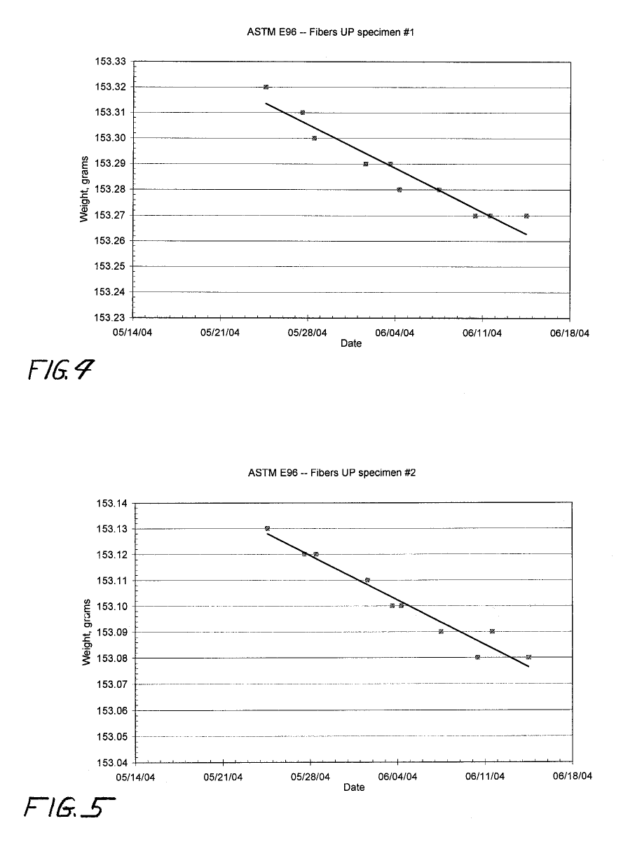

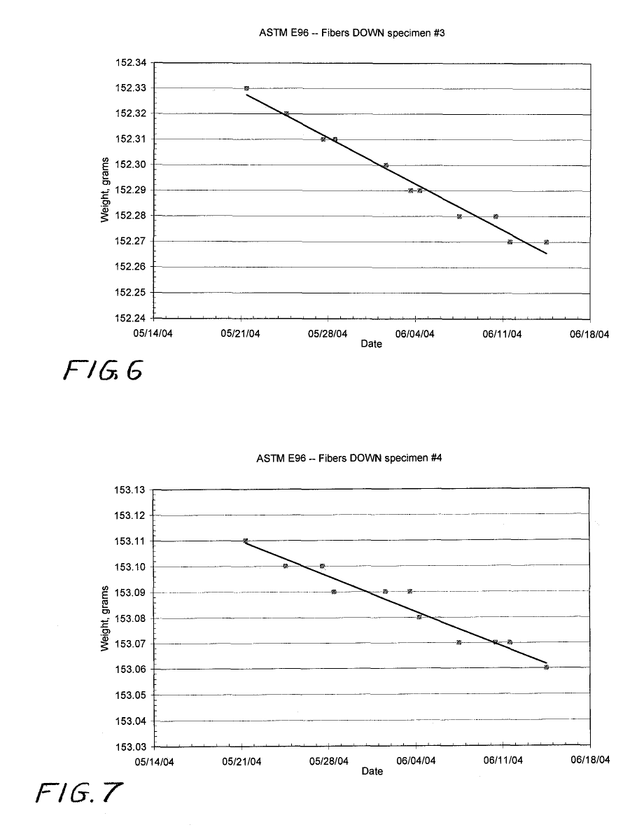

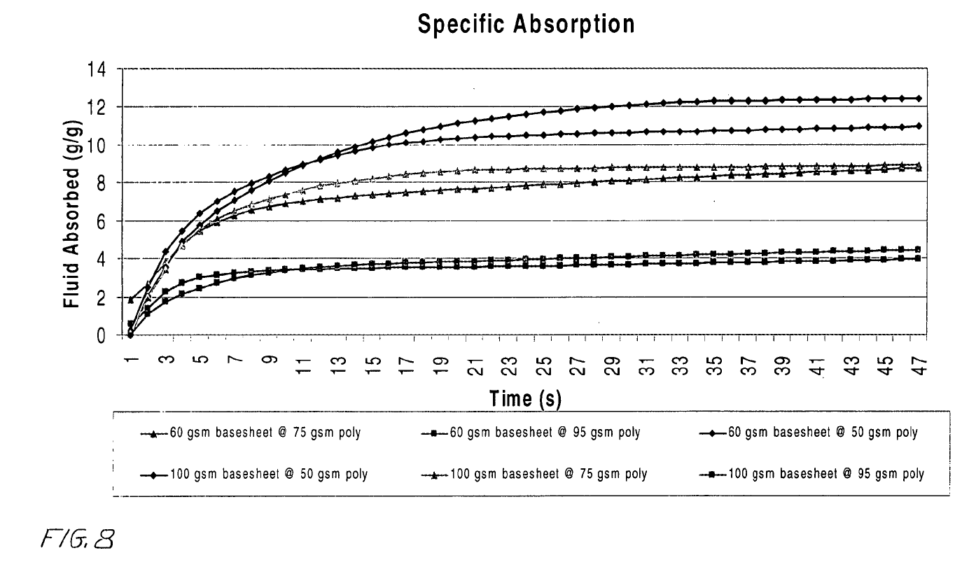

Table 1 summarizes results of a water vapor transmission and permeance test performed on some embodiments of concrete curing blanket 10 in general accordance with ASTM E96-00, “Standard Test Methods for Water Vapor Transmission of Materials” using the water method. FIGS. 4-7 show the portion of data used to calculate results. FIGS. 4 and 5 pertain to test samples oriented such that absorbent layer 15 was vertically superior to impervious layer 20, defining a fibers up position, and FIGS. 6 and 7 pertain to test samples oriented such that impervious layer 20 was vertically superior to absorbent layer 15, defining a fibers down position.

TABLE 1
Water Vapor Transmission and Permeance Data

| | Water vapor transmission | | | | Permeance | |
|---|---|---|---|---|---|---|
| | SI units | | inch-pound | | perm (grains/ | |
| Specimen | (grams/ | | units grains/ | | h · sq | |
| identification | h · sq m) | | h · sq ft | | ft · in · Hg) | |
| and orientation | | average | | average | | average |
| Specimen 1 fibers up | 0.040 | 0.040 | 0.057 | 0.057 | 0.14 | 0.14 |
| Specimen 2 fibers up | 0.040 | | 0.057 | | 0.14 | |
| Specimen 3 fibers | 0.042 | 0.037 | 0.060 | 0.053 | 0.14 | 0.13 |
| down | | | | | | |
| Specimen 4 fibers | 0.032 | | 0.046 | | 0.11 | |
| down | | | | | | |

| | | | |
|---|---|---|---|
| Average | 0.040 | 0.058 | 0.13 |

For this test, sample material was cut into four 52 mm diameter circles and placed on anodized aluminum permeability cups manufactured by Sheen Instruments Ltd. Two specimens were placed in the fibers up position and two in the fibers down position. The specimens were allowed to equilibrate for seven days in a test room maintained at 73±0.60° C. and 50±2% relative humidity (RH). The specimens then were sealed in the permeability cups over 6 mL reagent water (ASTM D1193 Type IV). A non-volatile, proprietary sealant was used to create a leak-free seal between the film and the cup faying surfaces. The specimens remained in the test room at 73±0.60° C. and 50±2% RH and were weighed in the room twice per week. The specimens were weighed until the weight change versus time was constant per ASTM E96. The referenced material meets the performance requirement for water vapor transmission rate of no more than 10 grams/m² in 24 hours (0.42 grams/hm²) in ASTM C 171-03, “Standard Specification for Sheet Materials for Curing Concrete.”

Results for Specimens 1 through 3 were similar, as shown on FIGS. 4-6. Specimen 4, as shown on FIG. 7, developed a visible biological growth on the fiber side mid-way through the testing. Specimen 4 has lower water vapor transmission. The accuracy of the balance is 0.01 grams, therefore all data points fall on the horizontal grid lines.

Another test measured the water retention of concrete curing blanket 10 in accordance with ASTM C156-98, “Standard Test Method for Water Retention by Concrete Curing Materials.” The test involved a composition of mortar containing by weight: 2,660 g concrete; 6,500 g standard sand; and 1,064 mL water to produce flow 35±5. The flow was 35.5% and water-to-concrete ratio was 0.4. Concrete curing blanket 10 met the performance requirement for water loss of no more than 0.55 kg/sq m in 72 hours per ASTM C171-97a, “Standard Specification for Sheet Materials for Curing Concrete.”

The specific composition of concrete curing blanket 10 provides a thickness, MD dry tensile strength, CD dry tensile strength, CD wet tensile strength, absorbency rate, capacity, brightness, and caliper that allow concrete curing blanket 10 to lay completely flat on, provide increased surface-to-surface contact with, and promote desired, consistent coloration of curing concrete. MD dry tensile strength refers to the tensile strength of a dry sample in the direction of the fibers. CD dry tensile strength refers to the tensile strength of a dry sample transversely to the direction of fibers. CD wet tensile strength refers to the tensile strength of a wet sample transversely to the direction of fibers. Concrete cured with concrete curing blanket 10 are free of localized weaknesses and discolorations caused by bubbles or other contact discontinuities between the curing surface and a concrete curing blanket. Further, increased weight from absorption causes the saturated blanket to remain in place longer and require less attention.

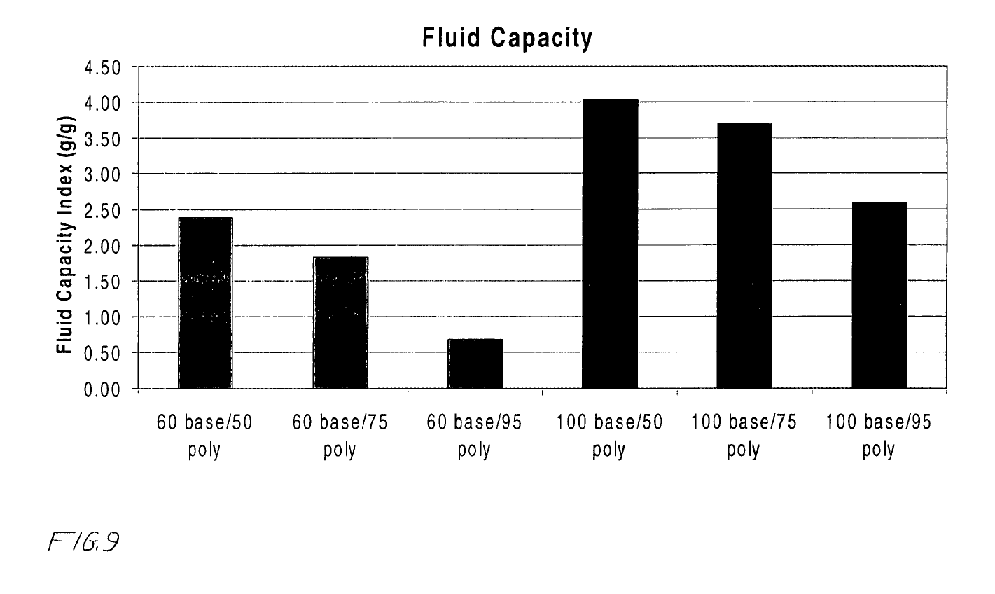

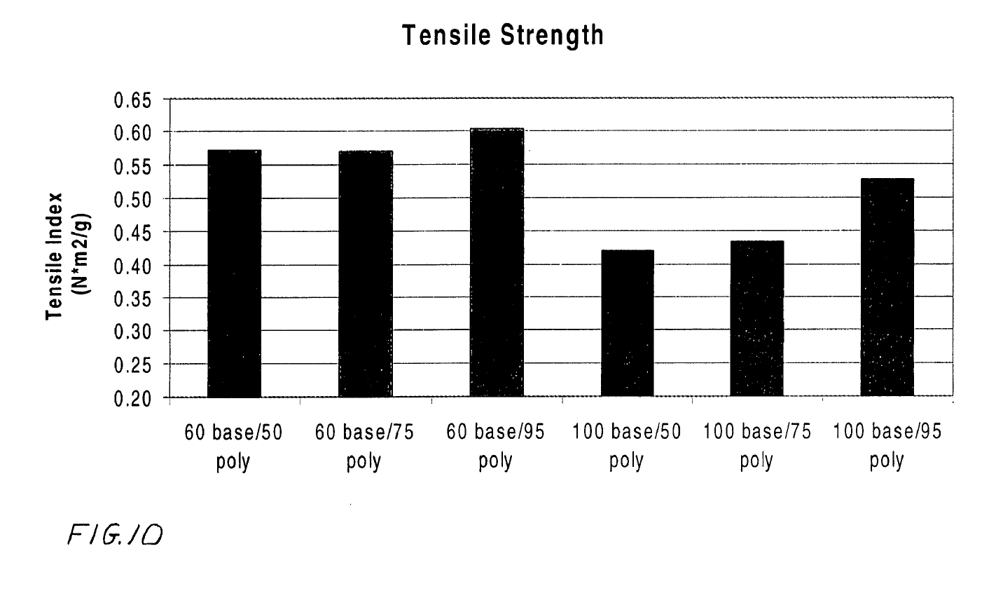

FIGS. 8-10 graphically describe, respectively, specific absorption, fluid capacity and tensile strength of various configurations of concrete curing blanket 10. Materials exhibit two different tensile strengths: (1) yield, which is equivalent to the maximum amount of tensile stress the material can withstand yielding or stretching; and (2) failure, which is equivalent to the stress required to achieve material failure or tearing. Table 2, below, presents data averaged from three tests of various configurations of concrete curing blanket 10.

TABLE 2
Preliminary Teat Data

| | | | Pulp | Pulp | Pulp | Pulp | Burst | | | | | Capac- | | |
|---|---|---|---|---|---|---|---|---|---|---|---|---|---|---|
| | Basis | | Up | Up | Down | Down | Index | | | % | Capac- | ity | | Capacity |
| Sample | Wt. | Caliper | Mullen | Mullen | Mullen | Mullen | (kPa | Tensile | Tensile | Elonga- | ity | Index | Capacity | Retention |
| Type | (gsm) | (mm) | (psi) | (kPa) | (psi) | (kPa) | m2/g) | (N/5 cm) | Index | tion | (g) | (g/g) | Retention | Index |
| 60 gsm | 109 | 0.389 | 16 | 110 | 18.8 | 130 | 1.19 | 62 | 0.57 | 11.64 | 9.34 | 2.38 | 4.01 | 1.02 |
| pulp sheet | | | | | | | | | | | | | | |
| @ 30# poly | | | | | | | | | | | | | | |
| 60 gsm | 129 | 0.398 | 20.5 | 141 | 22.4 | 154 | 1.2 | 73 | 0.57 | 10.45 | 8.54 | 1.84 | 4 | 0.86 |
| pulp sheet | | | | | | | | | | | | | | |
| @ 45# poly | | | | | | | | | | | | | | |
| 60 gsm | 157 | 0.296 | 25.8 | 178 | 27.3 | 188 | 1.2 | 95 | 0.6 | 8.65 | 3.88 | 0.69 | 2.21 | 0.39 |
| pulp sheet | | | | | | | | | | | | | | |
| @ 60# poly | | | | | | | | | | | | | | |
| 100 gsm | 151 | 0.808 | 28 | 193 | 35.7 | 246 | 1.63 | 64 | 0.42 | 12.54 | 21.99 | 4.03 | 6.49 | 1.19 |
| pulp sheet | | | | | | | | | | | | | | |
| @ 30# poly | | | | | | | | | | | | | | |
| 100 gsm | 158 | 0.79 | 24.1 | 166 | 30 | 207 | 1.31 | 69 | 0.44 | 12 | 21.04 | 3.7 | 9.76 | 1.71 |
| pulp sheet | | | | | | | | | | | | | | |
| @ 45# poly | | | | | | | | | | | | | | |
| 100 gsm | 201 | 0.718 | 30.3 | 209 | 37.7 | 260 | 1.3 | 106 | 0.53 | 10.55 | 18.72 | 2.59 | 7.54 | 1.04 |
| pulp sheet | | | | | | | | | | | | | | |
| @ 60# poly | | | | | | | | | | | | | | |
| Non-woven | 305 | 1.646 | 237.5 | 1636 | 257.2 | 1772 | 5.82 | 485 | 1.59 | 64.06 | 17.36 | 1.58 | 1.34 | 0.12 |
| poly w/ | | | | | | | | | | | | | | |
| poly | | | | | | | | | | | | | | |
| coating | | | | | | | | | | | | | | |

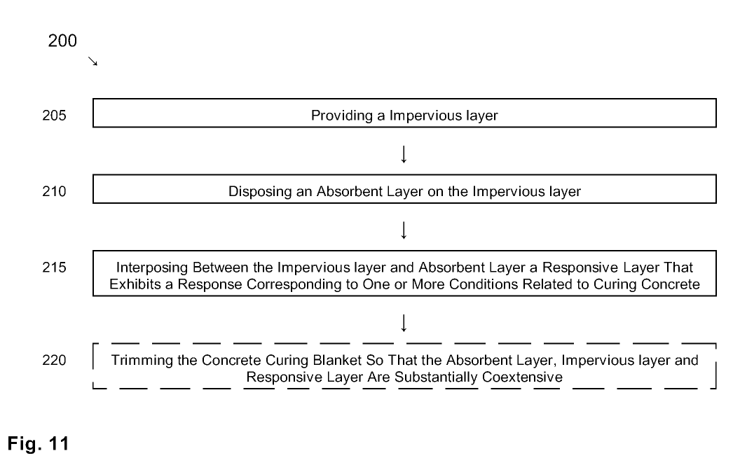

Referring to FIG. 11, a method of making a concrete curing blanket 200 according to principles of the invention includes: step 205 of providing an impervious layer; step 210 of disposing an absorbent layer on the impervious layer; and step 215 of interposing between the impervious layer and absorbent layer a responsive layer that exhibits a response corresponding to one or more conditions related to curing concrete, as described above.

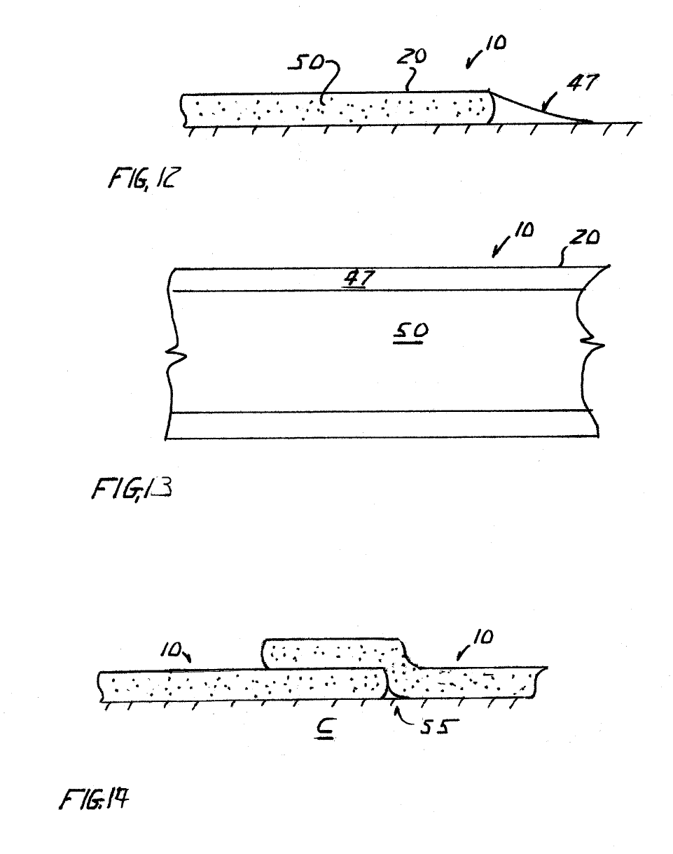

Referring to FIGS. 12 and 13, current manufacturing techniques initially produce an embodiment a concrete curing blanket 10 as shown, with a portion 47 of impervious layer 20 that extends beyond absorbent layer 15 and/or responsive layer 25 (collectively indicated with reference character 50). If left in this untrimmed state and disposed on curing concrete according to method 100, portion 47 would prevent the absorbent layer 15 of an overlapping segment of concrete curing blanket 10 from contacting the curing concrete and providing sufficient available water therealong for optimal curing. Consequently, a concrete slab cured with an untrimmed concrete curing blanket 10 would exhibit bands where the concrete did not cure as optimally.

Accordingly, if needed to assure coextensiveness of absorbent layer 15, impervious layer 20 and responsive layer 25, method 200 should include a step 220 of trimming the concrete curing blanket so that the absorbent layer, impervious layer and responsive layer are substantially coextensive.

Referring to FIG. 14, whether step 220 is required, portions of trimmed concrete curing blanket 10 would overlap as shown, without excess impervious layer 20 to interfere with the curing concrete C from contact by and water distribution from absorbent layer 15. While a minimal gap 55 is shown, in practice, absorbent layer 15 swells and fills gap 55, thereby providing a continuous, uniformly-distributing concrete curing blanket that indicates where appropriate hydration exists, therefore where optimal curing will occur.

Steps 205 and 210 are described above, therefore discussed no further.

Step 215 may involve applying the responsive layer to the absorbent layer or the impervious layer. For example, either of the absorbent layer or impervious layer could be metallized or spray coated with material appropriate for achieving the intended functions of the responsive layer.

The invention is not limited to the particular embodiments described herein, rather only to the following claims.

We claim:

1. Concrete curing blanket comprising:
an impervious layer;
an absorbent layer; and
a responsive layer between said impervious layer and said absorbent layer that exhibits a response corresponding to one or more conditions related to curing concrete.

2. Concrete curing blanket of claim 1, wherein said impervious layer is clear or opaque.

3. Concrete curing blanket of claim 1, wherein said impervious layer is a vapor barrier.

4. Concrete curing blanket of claim 1, wherein said impervious layer and said absorbent layer are thermally and/or latex bonded.

5. Concrete curing blanket of claim 1, wherein said impervious layer is constructed from a laminated, extruded or coated polyethylene or polymer latex material.

6. Concrete curing blanket of claim 1, wherein said impervious layer is UV enhanced and/or bio-degradable.

7. Concrete curing blanket of claim 1, wherein said absorbent layer is airlaid.

8. Concrete curing blanket of claim 1, wherein said absorbent layer comprises 5-50% synthetic bonding fibers by weight.

9. Concrete curing blanket of claim 1, wherein said absorbent layer comprises 5-35% latex binders by weight.

10. Concrete curing blanket of claim 1, wherein said absorbent layer comprises 1-10% multibond fibers by weight.

11. Concrete curing blanket of claim 1, wherein said absorbent layer comprises 50-89% natural cellulose fluffed pulp fiber by weight.

12. Concrete curing blanket of claim 1, wherein said absorbent layer contains 5-20% super absorbent fibers by weight.

13. Concrete curing blanket of claim 1, wherein said absorbent layer contains a sufficient amount of ethyl vinyl acetate to reduce dusting.

14. Concrete curing blanket of claim 1, wherein said absorbent layer comprises:
bi-component or multibond fibers; and
short-fiber fluff pulp obtained from Kraft processing.

15. Concrete curing blanket of claim 1, wherein said responsive layer is metallized.

16. Concrete curing blanket of claim 1, wherein said responsive layer has an optical density ranging from 0.05 to 10.0.

17. Concrete curing blanket of claim 1, wherein the response is dissolution or a color change.

18. Concrete curing blanket of claim 1, wherein the one or more conditions are selected from an amount of water, a pH level, a pH change and combinations thereof.

19. Concrete curing blanket of claim 1, wherein said concrete curing blanket has a caliper ranging from 0.5 to 5.0 mm.

20. Concrete curing blanket of claim 1, wherein said concrete curing blanket has a tensile strength ranging from 1,295 to 1,350 g/50 mm.

21. Concrete curing blanket of claim 1, wherein said concrete curing blanket has an absorbency of 17 g/g.

22. Concrete curing blanket of claim 1, further comprising a release agent disposed on said absorbent layer so that, when said concrete curing blanket is disposed on curing concrete, said release agent is interposed between said absorbent layer and the curing concrete.

23. Method of curing concrete comprising:
wetting a target curing concrete surface; and
disposing the concrete curing blanket of claim 1 on the target curing concrete surface.

24. Method of making a concrete curing blanket comprising:
providing an impervious layer;
disposing an absorbent layer on the impervious layer; and
interposing between the impervious layer and absorbent layer a responsive layer that exhibits a response corresponding to one or more conditions related to curing concrete.

25. Method of claim 24, wherein said response is dissolution or a color change.

26. Method of claim 24, wherein the one or more conditions are selected from an amount of water, a pH level, a pH change and combinations thereof.

27. Method of claim 24, further comprising, following said disposing, trimming the concrete curing blanket so that the absorbent layer, impervious layer and responsive layer are substantially coextensive.

28. Method of claim 24, wherein said interposing comprises, prior to said disposing, applying the responsive layer to the absorbent layer or the impervious layer.
